(19) United States
(12) Patent Application Publication
(10) Pub. No.: US 2004/0208734 A1
(43) Pub. Date: Oct. 21, 2004

(54) Device to move large auto parts

(76) Inventors: Julian C. Shoemyer, Monroe City, MO (US); James L. Wisdom, Hunnewell, MO (US)

Correspondence Address: LITMAN LAW OFFICES, LTD., P.O. BOX 15035 CRYSTAL CITY STATION, ARLINGTON, VA, 22215, US

(21) Appl. No.: 10/417,076

(22) Filed: Apr. 17, 2003

(51) Int. Cl. B66F 9/14

(52) U.S. Cl. 414/607

(57) ABSTRACT

The present invention is a device to move large auto parts, being an adaptor for a forklift. The adaptor has a frame having a horizontal section for mounting on the forklift prongs and a vertical raised section having upper and lower portions for attachment and loading at upper and lower parts of the large auto part. The adaptor attaches to the forklift by way of a safety chain that is adjustable and secures the adaptor to the forklift at an upper portion. Two prongs are mounted on the lower part of the vertical section in the same plane as the horizontal section. The adaptor prongs are adjustable in position and have different size or shape.

### BACKGROUND OF THE INVENTION

1. Field of the Invention

The present invention relates generally to devices to move large auto parts and more specifically to a device that attaches to an ordinary fork lift and which allows for lifting and movement of large auto parts that have shapes and sizes not suited to the prongs of an ordinary fork lift.

2. Description of the Related Art

Forklifts are well known to allow individual personnel to load large objects onto a truck. Some large objects are shaped and sized so that they are inconvenient or impossible for the conventional forklift to load. Various prior art devices, arrangements, adaptors and attachments have been devised to allow individual personnel using a conventional forklift to load, lift and move large objects having unusual shapes and sizes. Large auto parts or clips have a variety of shapes and sizes that are also not suited for the conventional forklift. Many devices have been proposed to solve the problem of loading, lifting and moving unusual objects on to a truck, but these devices have many disadvantages with respect to large auto parts.

U.S. Pat. No. 2,362,991, issued on Nov. 21, 1944 to Dhal, discloses an adaptor for a forklift for lifting and moving the tail wheel or skid of an airplane. This adaptor mounts on the forks of a forklift in manner similar to the instant invention, but it has its members specifically shaped to accommodate and adequately hold the wheel or skid for lifting and moving, but is not adapted for large car parts.

U.S. Pat. No. 2,699,878, issued on Jan. 18, 1955 to Avery, discloses an adaptor for a forklift for lifting and moving dies. This adaptor mounts on the forks of a forklift in a manner similar to the instant invention, but it has its members specifically shaped to accommodate and adequately hold and unload the dies.

U.S. Pat. No. 3,556,328, issued on Jan. 19, 1971 to Miles et al., discloses an adaptor for a forklift for lifting and moving of ordinary palettes that a forklift usually loads, while working in narrow aisles. This adaptor mounts on the prongs of a forklift in a manner similar to the instant invention, but it has its members specifically shaped to accommodate and adequately hold the ordinary palettes that a forklift usually lifts, and provides more freedom of movement of those ordinary objects through narrow spaces.

U.S. Pat. No. 4,065,015, issued on Dec. 27, 1977 to Radakovich, discloses a frame assembly for a forklift for lifting and moving tote boxes, wherein the members of the frame form a continuous U shape without separate prongs.

U.S. Pat. No. 4,170,434, issued on Oct. 9, 1979 to Kress et al., discloses a vehicle for lifting and transporting steel slabs, which is in no way similar to the conventional forklift.

U.S. Pat. No. 4,395,188, issued on Jul. 26, 1983 to Kaup, discloses a forklift having a pair of fork prongs which have a load engaging portion and a mount portion, which can be mounted at different positions on the lift frame. The fork prongs mount on the forklift in a manner different than the adaptor of the instant invention.

U.S. Pat. No. 4,688,981, issued on Aug. 25, 1987 to Ravnsborg et al., discloses an adaptor for a forklift for lifting and moving ordinary forklift loads with more freedom of movement. This adaptor mounts on the forks of a forklift in a manner similar to the instant invention, but it has its members specifically shaped to accommodate and adequately hold objects that an ordinary forklift loads with greater downward vertical movement, such as down a pit.

U.S. Pat. No. 4,708,576, issued on Nov. 24, 1987 to Avery, discloses an adaptor for a forklift for lifting and moving of ordinary forklift loads that are wider in size than the conventional fork prongs are expected to hold. This adaptor mounts on the forks of a forklift in a manner not quite the same as the instant invention, and it has its members arranged to accommodate and adequately hold wider vertical loads, rather than large car parts that do not fit on rectangular fork prongs.

U.S. Pat. No. 4,890,973, issued on Jan. 2, 1990 to Frison et al., discloses an adaptor for a forklift for lifting and moving of slip sheets. This adaptor mounts on the forks of a forklift in a manner similar to the present invention, but it has members shaped to accommodate and adequately hold large flat sheets horizontally, including a complicated push-pull mechanisms.

U.S. Pat. No. 4,929,145, issued on May 29, 1990 to Thompson, discloses an adaptor for a forklift for lifting and moving bundles of vertical objects, such as pipes, into vertical storage racks. This adaptor mounts on the forks of a forklift in a manner similar to the present invention, but it has its members shaped in a circular tube arrangement to accommodate and adequately hold and load bundles of vertical objects into vertical storage racks.

U.S. Pat. No. 5,022,811, issued on Jan. 11, 1991 to Wallman, discloses an adaptor for a forklift for lifting and moving and loading of heavy objects onto the forks of the fork lift using a sliding plane and other grooves. This adaptor mounts on the forks of a forklift in a manner similar to the present invention, but its members include the sliding planes and other grooves.

U.S. Pat. No. 5,476,300, issued on Dec. 19, 1995 to Dodge, discloses an adaptor for a crane with a hook for lifting and moving of odd circular shaped objects. This adaptor does not mount on the forks of a forklift in a manner similar to the instant invention.

U.S. Pat. No. 5,486,083, issued on Jan. 23, 1996 to Thompson, discloses an adaptor for a forklift for lifting and moving of rectangular frames. This adaptor mounts on the forks of a forklift in a manner similar to the present invention, but it has its members shaped to accommodate and adequately hold and unload rectangular frames using powered levers.

U.S. Pat. No. 5,692,583, issued on Dec. 2, 1997 to Reed et al., discloses an adaptor for a forklift for lifting and moving of railway wheel assemblies. The adaptor mounts on the forks of a forklift in a manner similar to the present invention, but it has its members shaped to accommodate and adequately hold and unload the wheel assemblies via fork prongs that are essentially longer.

U.S. Pat. No. 6,024,529, issued on Feb. 15, 2000 to Kristensen, discloses an adaptor for a forklift for lifting and moving of large cylindrical objects. This adaptor mounts on the forks of a fork lift in a manner similar to the present invention, but it has its members shaped to accommodate and adequately hold and unload the large cylindrical object using vacuum-based suction cups.

U.S. Pat. No. 6,135,701, issued on Oct. 24, 2000 to Galloway, Sr., discloses an adaptor for a forklift for lifting and moving of trailers. This adaptor mounts on the prongs of a forklift in a manner similar to the present invention, but it has its members shaped to accommodate and adequately hold and unload the towing ball adaptor.

U.S. Pat. No. 6,200,083, issued on Mar. 13, 2001 to Hein, discloses an adaptor for a forklift for lifting and moving of a bucket shove. This adaptor mounts on the forks of a forklift in a manner similar to the present invention, but it has its members shaped to accommodate and adequately to provide a bucket shovel.

Therefore, it would be desirable to provide a forklift adaptor that mounts on the fork prongs of a forklift, but which fits and adjusts to the shapes and sizes of large auto parts. The large auto parts are sections or halves of the whole auto body, etc. The basic problem with the ordinary forklift in loading and carrying large auto parts is that the prongs do not have enough width or length. The present invention solves this problem by prongs on the adaptor, which are adjustable and wide enough to fit the bottom rocker panel area, but are much shorter than the auto part. Chains are fastened between an upper portion of the auto part and a tensioner on a vertical upper portion of the adaptor above the prongs on the adaptor.

It would also be desirable to provide an adaptor that has adjustable forks to fit into the bottom rocker panel areas of the large auto part and which has chains that hook to the top parts of the large auto part using a tightener device, and which also has a safety chain that secures the adaptor to the forklift at a top portion of the adaptor.

None of the above inventions and patents, taken either singly or in combination, is seen to describe the instant invention as claimed. Thus, an adaptor for a forklift shaped and adjustable to large auto parts solving the aforementioned problems is desired.

### SUMMARY OF THE INVENTION

The present invention is an adaptor for a forklift, which is shaped, sized and adjusted for carrying and holding large auto parts. The adaptor has a frame having a horizontal section for mounting on the forklift prongs and a vertical raised section having upper and lower portions for attachment and loading at upper and lower parts of the large auto part.

The adaptor's horizontal section will mount onto any forklift having fixed or adjustable fork prongs. The horizontal section can have as many as two pairs of receiving tubes to accommodate different sizes of forklift trucks, which have different spacing between the fork prongs. The upper portion of the adaptor attaches to the forklift by way of a safety chain that is adjustable, stored in a box and provides coupling to the forklift at an upper portion thereof.

Two adjustable adaptor prongs are mounted on the lower part of the vertical section in the same plane as the horizontal section. The prongs are shaped and sized to slide in the bottom rocker panel areas of the large auto part. The length of the prongs is not necessarily as long as the large auto part. The prongs are adjustable in position or distance between each other and are removable to be replaced by prongs of different size or shape.

Two tensioners are mounted on the top portion of the vertical section. The tensioners can be positioned with different distance between them and usually are positioned directly above the prongs on the lower portion. These tensioners allow one to easily tighten and untighten chains hooked between the tensioner and upper parts of the large auto part. Various types, styles and shapes of hooks on the end of the chain maybe used to clamp on to the upper part of the auto part. The tensioners are also removable, so that the tensioners can be replaced by tensioners of different size or shape in the same manner as prongs.

Therefore, the car part is securely loaded on to the adaptor. After the car part is positioned under the prongs, the chains are hooked to the upper parts, the chains are tensioned by the tensioner and the car part and adaptor combination are lifted by the forklift.

The adjustability and variety of the tensioners and prongs mentioned above means that the same basic frame of the adaptor and attachment to the forklift could be used with all kinds and shapes and sizes of large auto parts, even as automobiles are manufactured with different sizes and shapes.

In operation, the adaptor is mounted on to the forklift by lowering the fork prongs and positioning and moving them into the adaptor receivers. Then, the safety chain is pulled out of its chain box and one end is hooked on a hook bolted on the upper portion of the forklift lift assembly while a link on the other end at the chain box is hooked in to a slot on the top of the chain box.

Then the forklift is brought up close to the large auto part with the adaptor fork prongs lowered and positioned and moved in to the lower rocker panel of the auto part. Then, the two chains from the top portion of the adaptor or tensioners can be attached to the top portion of the auto part using specialized hooks or couplers. The other ends of the chain have one of their links hooked in to the hook on the tensioner screw. The crank handle is then turned to pull the hook and chain away from the car part in order to tighten the chain.

Accordingly, it is a principal object of the invention to provide an adaptor for a forklift which allows the forklift to hold and move large auto parts having large variety of shapes and sizes.

It is another object of the invention to provide an adaptor for a forklift that does not require more than one man to setup or to load a large auto part onto a forklift truck.

It is a further object of the invention to provide an adaptor for a forklift, which is changeable and adaptable to future changes in size and shape of large auto parts.

Still another object of the invention is to provide an adaptor for a forklift which holds and moves large auto parts, and that decreases labor and saves time.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental side view of the device to move large auto parts according to the present invention.

FIG. 2 is an environmental, perspective view of the device to move large auto parts according to the present invention.

FIG. 3 is a perspective view of the device to move large auto parts according to the present invention.

FIG. 4 is a fragmented, perspective view of the top portion tensioners of the device to move large auto parts according to the present invention.

FIG. 5 is a fragmented, perspective, view of the top and middle portion of the device to move large auto parts according to the present invention.

FIG. 6 is a fragmented, perspective view of a tensioner of the device to move large auto parts according to the present invention.

Similar reference characters denote corresponding features consistently throughout the attached drawings.

### DETAILED DESCRIPTION OF THE PREFERRED EMBODIMENTS

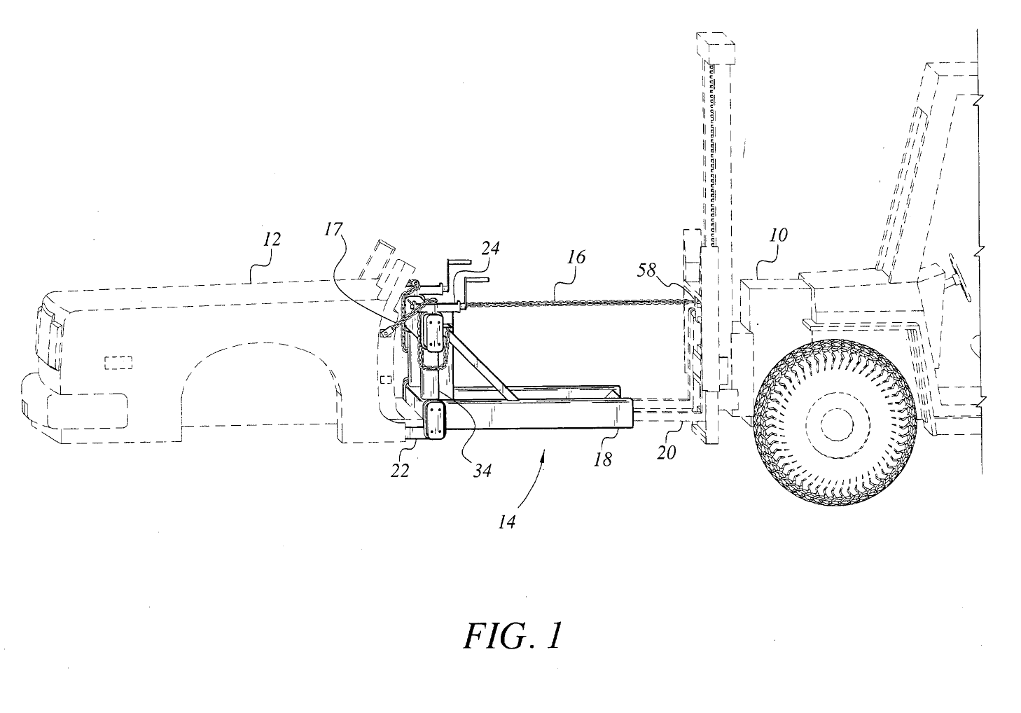

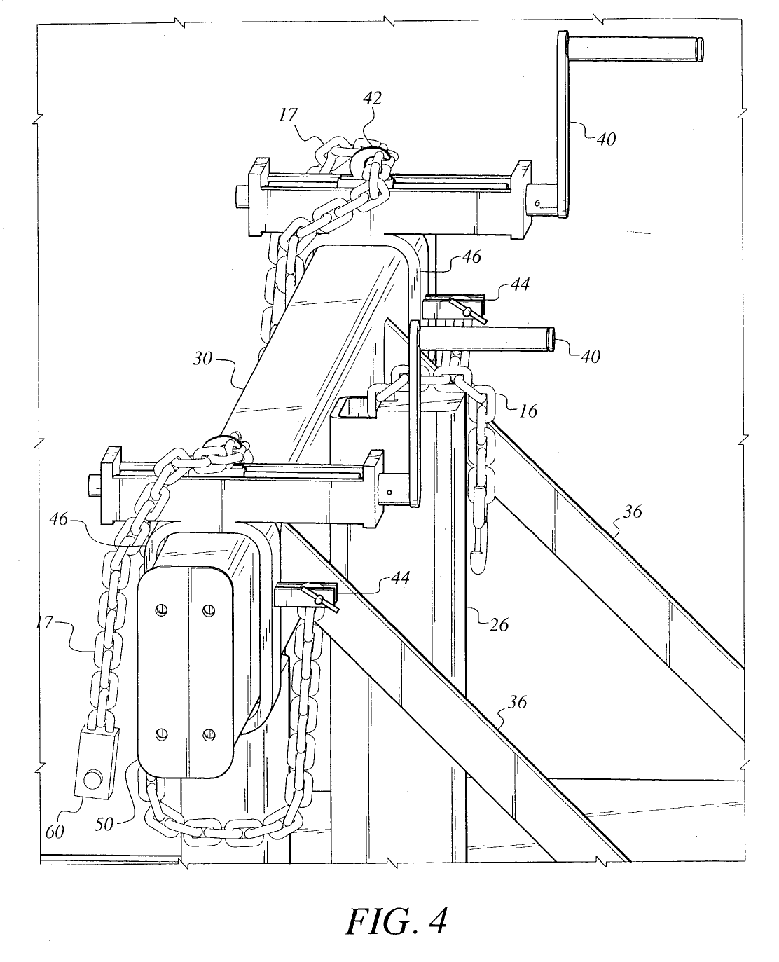

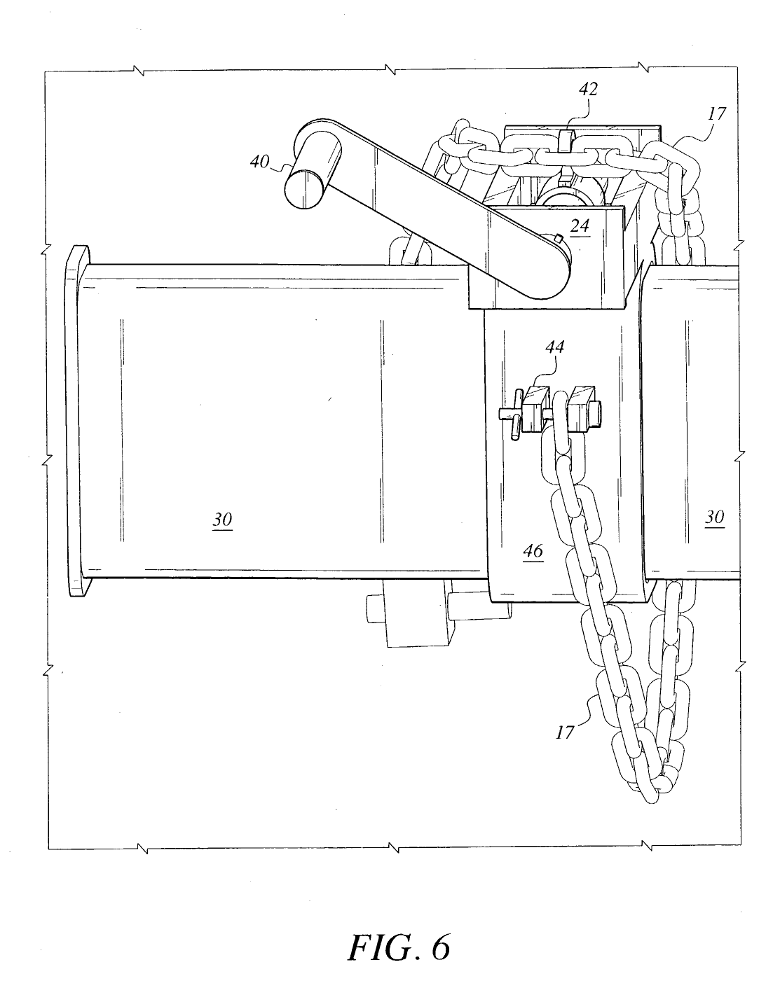

The present invention is a device to move large auto parts. FIG. 1 shows an exemplary environmental side view of the large auto part 12, an adaptor 14, and a forklift truck 10. The adaptor 14 has a pair of adaptor prongs 22 which slide into the lower portion or rocker panels of the large auto part 12. This keeps the large auto part 12 from slipping off the adaptor prongs 22. The large auto part 12 has its upper portion supported by the top chains 17 that are tensioned by the tensioners 24. Specially made hooks 60 at one of the ends of chains 17 connect to the door hinge pins of the auto part 12. Close up detail of the hook 60 is shown in FIG. 4. On the other end of the chains 17, one of the links locks into hooks 42 on the tensioner screw of the tensioner 24. Details of the link and the hook 42 and tensioner 24 are shown in greater detail in FIGS. 4 and 6 and described below.

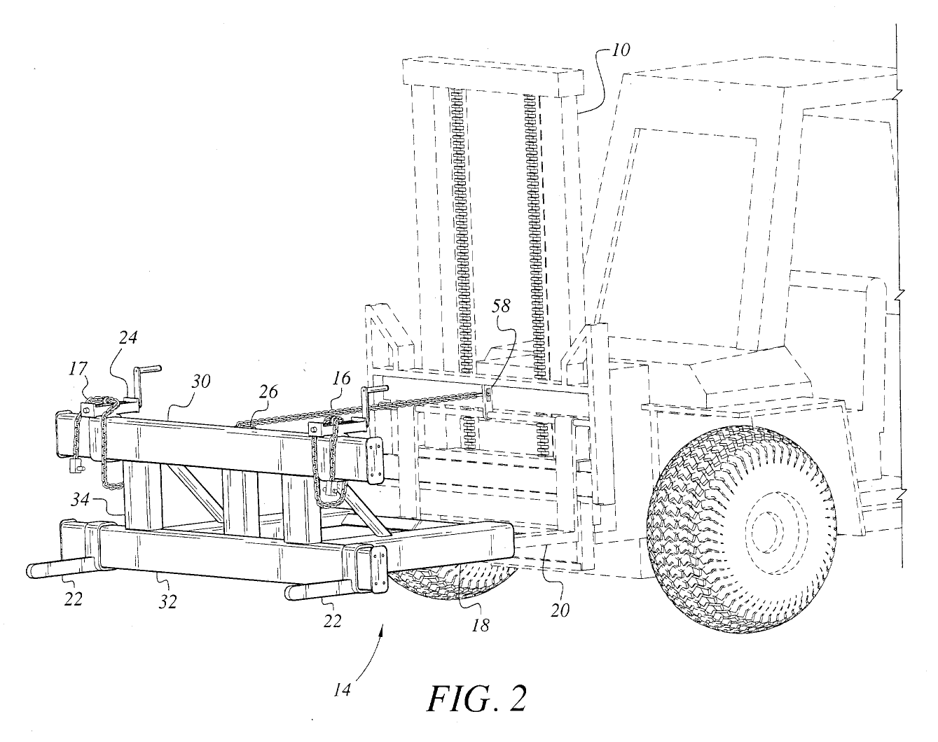

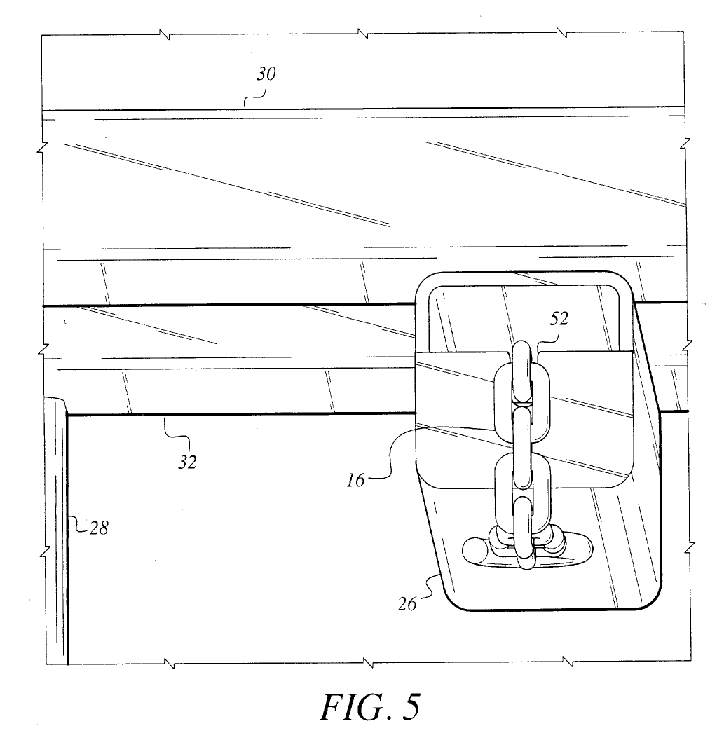

FIGS. 1 and 2 show the details of the attachment and mounting of the adaptor 14 onto the forklift 10 at four points. The first point is at one end of the chain 16 coupled to a hook 58 bolted on to a lift assembly of the forklift 10. At the second point the other end of chain 16 is hooked at the chain box 26 in slot 52 on the top plate. The details of hooking the chain 16 in the slot 52 at the chain box 26 are shown in FIG. 5 and described below. The third and fourth points are the tubular steel receivers 18 or 28 of the adaptor 14, which slide into the fork prongs 20 of the forklift 10.

In operation with regard to FIGS. 1, 2 and 5, the adaptor 14 is mounted on to the forklift 10 by lowering the fork prongs 20 and positioning and sliding them into the adaptor receivers 18. Then, the safety chain 16 is pulled out of its chain box 26 and one further away link in the chain 16 is hooked on a hook 58 bolted on the upper portion of the forklift 10 lift assembly while a link on the other end at the chain box 26 is hooked in to a slot 52 on the top of the chain box 26.

After the adaptor 14 is mounted onto the forklift 10, the forklift 10 with the adaptor 14 is brought up close to the large auto part 10 with the adaptor prongs 22 lowered, positioned and slid in to the lower rocker panel of the auto part 12. Then, the left and right hand chains 17 from the tensioner 24 of the adaptor 14 can be attached to the top portion of the auto part 12 using specialized hooks or couplers. See FIGS. 4 and 6. The other ends of the left and right hand chains 17 have one of their links hooked in to the hook 42 of the tensioner 24. The left and right hand crank handles 40 are then turned to pull the hooks 42 and chains 17 away from the car part 12 in order to tighten the chains 17.

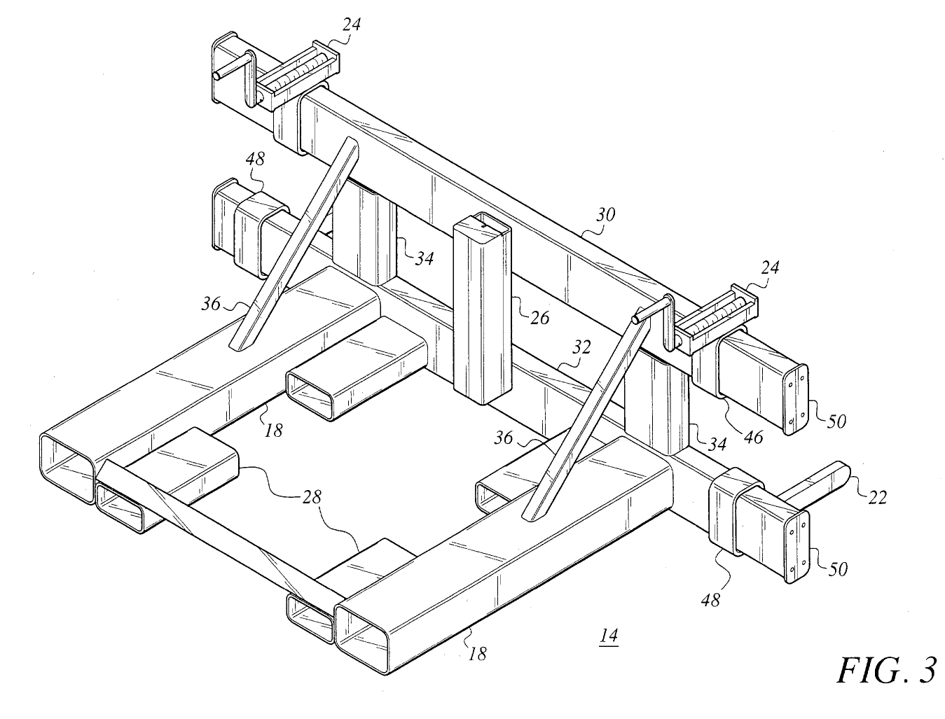

FIG. 3 shows the close up view of the exemplary adaptor frame 14 with all its structures. Receiver tubes 18 and 28 are made of heavy gauge steel. Receiver tubes 18 and 28 provide slide on connection and slide off disconnection to the fork prongs 20 of the forklift 10 in two different widths. The receiver tubes 18 and 28 are coupled with a lower frame member 32, which is made of the same heavy gauge steel. The adaptor 14 is further built up vertically via steel support tubes 34. Tubes 34 are made of the same heavy gauge steel. The tubes 34 are positioned on the right and left hand sides and are coupled between the lower frame member 32 and upper frame member 30. The upper frame member 30 is made of the same heavy gauge steel. Support bars 36 on the right and left hand sides provide additional support between the vertical section 30 and 34 and horizontal section 18, 28 and 32. The support bars 36 are made of the same heavy gauge steel. The support bars 36 are positioned at a 45-degree angle to the vertical and horizontal sections and coupled between upper frame member 30 and receiver tubes 18.

A steel chain box 26 is provided in the center of the width of the adaptor 14 and is coupled between the lower frame member 32 and the upper frame member 30. The chain box 26 is placed in the middle as shown and provides extra support between the upper and lower frame members 30 and 32 of the adaptor 14.

In FIG. 3, right and left hand prongs 22 are mounted on the lower frame member 32 by brackets 48, which wrap around the frame member 32. The brackets 48 allow the prongs 22 to be positioned and/or fixed securely at different widths between each other. The brackets 48 also allow the prongs 22 to be removed and replaced by other styles or designs or sizes of prongs 22 when the end plates 50 are removed and replaced.

With regard to FIGS. 3 and 5, the bottom of the chain box 26 is closed off at the bottom so as to store the chain 16 when not in use. The top of the chain box 26 is half way open in order to unload the chain 16. The half closed top of the chain box 26 has small slot like 52 opening just large enough to capture and securely hold a link in the chain 16 when the other end of the chain 16 is hooked to the forklift 10 at hook 58 as shown in FIG. 2. Therefore, no special hook need be mounted on the top of the chain box 26, although this is another alternative.

In FIGS. 3 and 4, right and left hand tensioners 24 are mounted on the upper frame member 30 by brackets 46, which wrap around the frame member 30. The brackets 46 allow the tensioners 24 to be positioned and/or fixed securely at different widths between each other and above the prongs 22. The brackets 46 also allow the tensioners 24 to be removed and replaced by other styles or designs of tensioners or chain holders when the end plates 50 are removed and replaced. This is also shown in greater detail in FIGS. 4 and 6.

FIGS. 4 and 6 show a close up view of the tensioners 24. The tensioners 24 contain a hook 42 mounted a screw (not well shown) turned by handle 40 all mounted in a box structure. The chain 17, which tightly secures the top portion of the large auto part 12 through the tension hook 42 is secured on the last end of the chain 17 by a pin and bracket 44. The pin and bracket 44 provide extra safety. The rest of the chain 17 is then loosely wrapped around the upper frame 30 to the top of the tensioner 24 to engage the hook 42 of the tensioner 24 at one of the links. FIG. 4 shows a detailed example of the special hook 60 that would hook to the door hinge of the large auto part 12. Therefore, when the crank handle 40 is turned the hook 42 will move away from or to the large auto part 12 causing tension on the chain 17 to be increased or decreased.

A feature of the present invention is to provide auto salvage dealer, body shop or car rebuilder, with the ability to pick up and move front and rear automotive clips (large car parts) via the forklifts that they already have. The adaptor has the ability as shown in the exemplary embodiment above to adapt to several forklifts and auto part shapes and sizes. To this end, labor, personnel and time and insurance needed to move and place parts is saved.

It is to be understood that the present invention is not limited to the sole embodiments described above, but encompasses any and all embodiments within the scope of the following claims.

We claim:

1. An adaptor for mounting on a forklift for moving large auto parts, comprising:
a pair of forklift prong receivers adapted for sliding onto prongs of said forklift
a vertical frame having upper and lower frame members coupled together, the lower frame member being attached to said pair of forklift prong receivers;
an attachment box coupled to said upper frame member;
a first chain coupled between said attachment box and an upper portion of said forklift;
a pair of tensioner members coupled on said upper frame member on opposite sides;
a pair of prongs coupled on said lower frame member on opposite sides and facing opposite said fork prong receivers in order to engage a lower portion surface of the auto part;
second and third chains coupled to said tensioner members at one end, and adapted for coupling at another end to upper portions of the auto part.

2. The adaptor for mounting on a forklift as claimed in claim 1, wherein said vertical frame comprises a pair of spaced apart coupling beams vertically coupled between said upper and lower frame members.

3. The adaptor for mounting on a forklift as claimed in claim 2, wherein a pair of support bars are coupled between said pair of forklift prong receivers and said upper frame member.

4. The adaptor for mounting on a forklift as claimed in claim 3, wherein said pair of support bars are positioned at a 45 degree angle between said pair of forklift prong receivers and said upper frame member.

5. The adaptor for mounting on a forklift as claimed in claim 1, wherein said pair of tension members comprise a hook coupled to a screw further coupled to a handle housed and supported in a box structure.

6. The adaptor for mounting on a forklift as claimed in claim 5, wherein said second and third chains have links near the end of said second and third chains hooked into said hooks so that when said handle is turned said second and third chains are drawn tighter.

7. The adaptor for mounting on a forklift as claimed in claim 1, wherein said pair of tensioner members are coupled to said upper frame member by a bracket which allows movement along said upper frame member.

8. The adaptor for mounting on a forklift as claimed in claim 1, wherein said pair of prongs are coupled to said lower frame member by a bracket which allows movement along said lower frame member.

9. The adaptor for mounting on a forklift as claimed in claim 1, wherein said attachment box includes space for storing said first chain.

10. The adaptor for mounting on a forklift as claimed in claim 1, wherein said attachment box includes a slot-like opening at its top for engaging and hold a link near an end of said first chain.

11. The adaptor for mounting on a forklift as claimed in claim 9, wherein said attachment box includes a slot like opening at its top for engaging and hold a link near an end of said first chain.

12. The adaptor for mounting on a forklift as claimed in claim 1, comprising a second pair of prong receiver means coupled to said forklift prong receiver means to slide on to prongs of a smaller forklift.

13. The adaptor for mounting on a forklift as claimed in claim 2, further comprising a second pair of prong receiver means coupled to said forklift prong receiver means to slide on to prongs of a smaller forklift.

14. The adaptor for mounting on a forklift as claimed in claim 7, wherein a pair of removable end pieces on each end of said upper and lower frame members allow said tensioner means to be removed.

15. The adaptor for mounting on a forklift as claimed in claim 8, wherein a pair of removable end pieces on each end of said upper and lower frame members allow said prong means to be removed.

16. An adaptor for mounting on a forklift comprising:
a pair of forklift prong receivers;
said pair of forklift prong receivers slide on to prongs of said forklift
a vertical frame having upper and lower frame members coupled together by a pair of spaced apart coupling beams vertically coupled between said upper and lower frame members;
said lower frame member coupled to ends of said pair of forklift prong receivers;
a pair of support bars are coupled between said pair of forklift prong receivers and said upper frame;
an attachment box coupled between said upper and said lower frame members;
a first chain coupled between said attachment box and an upper portion of said forklift;
a pair of tensioner means coupled on said upper frame member on opposite sides;
a pair of prong means coupled on said lower frame member on opposite sides;
said pair of prong means facing opposite said fork prong receivers to engage a lower portion surface of an auto part;
second and third chains coupled to said tensioner means at one end;
and said second and third chains coupled at another end to upper portions of said auto part.

17. The adaptor for mounting on a forklift as claimed in claim 16, wherein said pair of support bars are positioned at a 45 degree angle between said pair of forklift prong receivers and said upper frame member.

18. The adaptor for mounting on a forklift as claimed in claim 16, wherein said pair of tensioner means comprises a hook coupled to a screw further coupled to a handle housed and supported in a box structure.

19. The adaptor for mounting on a forklift as claimed in claim 18, wherein said second and third chains have links near the end of said second and third chains hooked into said hooks so that when said handle is turned said second and third chains are drawn tighter.

20. The adaptor for mounting on a forklift as claimed in claim 1 wherein said pair of tensioner means are coupled to said upper frame member by a bracket which allows movement along said upper frame member.
